(19) United States
(12) Patent Application Publication
(10) Pub. No.: US 2016/0188030 A1
(43) Pub. Date: Jun. 30, 2016

(54) TOUCH-CONTROLLED LIQUID CRYSTAL DISPLAY PANEL AND APPARATUS USING THE SAME

(71) Applicant: Shenzhen China Star Optoelectronics Technology Co., Ltd., Shenzhen (CN)

(72) Inventors: Jianxing Xie, Shenzhen (CN); Yao-Li Huang, Shenzhen (CN); Chun-Hung Huang, Shenzhen (CN)

(73) Assignee: Shenzhen China Star Optoelectronics Technology Co., Ltd., Shenzhen (CN)

(21) Appl. No.: 14/416,279

(22) PCT Filed: Dec. 29, 2014
(86) PCT No.: PCT/CN2014/095304

§ 371 Date: Jan. 22, 2015

(30) Foreign Application Priority Data
Dec. 24, 2014 (CN) 201410814003.9

(51) Int. Cl. G06F 3/044; G09G 3/36; G06F 3/047; G06F 3/041

(52) U.S. Cl. CPC G06F 3/044; G06F 3/0412; G06F 3/0416; G09G 3/3648; G06F 3/047; G06F 2203/04103

(57) ABSTRACT

A touch-controlled liquid crystal display panel is disclosed and includes a first substrate, a TFT array layer, a common-electrode layer having a plurality of common electrodes, a touch-sensing layer, a dielectric layer, a pixel electrode layer, a liquid crystal layer and a second substrate having a black matrix. The touch-sensing layer includes a plurality of touch-sensing wires. Each of the touch-sensing wires is connected to the corresponding common electrode. The display panel is simple in structure so that the product yield rate can be increased and the production cost can be reduced.

### BACKGROUND OF THE INVENTION

1. Field of the Invention

The present invention relates to the field of display technology, and more particularly to a touch-controlled liquid crystal display panel and a touch-controlled liquid crystal display apparatus.

2. Description of the Related Art

With the increasing prevalence of intelligent electronic devices, capacitive touch screens have widely applied to all kinds of electronic products, such as smart phones and tablet personal computers. The structure for a conventional capacitive touch screen can be classified into add-on and embedded types. In recent years, people tend to pursue thinner touch-controlled products, thereby leading to a situation of three kinds of technologies, GGS (One Glass Solution), On-cell and In-cell, competing against each other. However, an In-cell capacitive touch screen has an outstanding advantage in manufacturing process that it can be made thinner and with better light-transmitting characteristic. Thus, to fulfill the requirements of consumers, In-cell capacitive touch screens inevitably will become the mainstream of the future market.

However, in a traditional full in-cell touch screen, the sensing electrodes and the signal wires are initially insulated from each other because they are mounted in different layers. Thus, it is necessary to form conducting through holes to connect the sensing electrodes and the connecting wires, thereby resulting in a complicated structure and causing a problem of low yields.

Therefore, it is necessary to provide a new technical solution to overcome the technical problems existing in foregoing conventional technology.

### SUMMARY OF THE INVENTION

An object of the present invention is to provide a touch-controlled liquid crystal display panel and a touch-controlled liquid crystal display apparatus which have a simple structure that is easier to manufacture so as to enhance yield rate and lower production cost.

In order to solve the foregoing technical problem, the present invention provides a touch-controlled liquid crystal display panel including:

a first substrate;

a TFT array layer mounted on the first substrate;

a common-electrode layer mounted on the TFT array layer and having a plurality of common electrodes arranged in an array manner;

a touch-sensing layer mounted on the common-electrode layer for receiving a touch-input signal;

a dielectric layer mounted on the touch-sensing layer for insulating the common-electrode layer and a pixel-electrode layer from each other, wherein the pixel-electrode layer is mounted on the dielectric layer;

a liquid crystal layer mounted on the pixel-electrode layer; and

a second substrate mounted on the liquid crystal layer and having a black matrix; wherein

the touch-sensing layer includes a plurality of touch-sensing wires; each of the touch-sensing wires is connected to the corresponding common electrode; each of the touch-sensing wires includes a transversely-extended portion and a longitudinally-extended portion, wherein the transversely-extended portion is electrically connected to the corresponding common electrode, and the longitudinally-extended portion is electrically connected to a control circuit; the touch-sensing wires on the touch-sensing layer are mounted in positions corresponding to the black matrix of the second substrate.

Preferably, in the touch-controlled liquid crystal display panel, when the touch-controlled liquid crystal display panel is displaying images, the control circuit provides a common signal to all the common electrodes through the touch-sensing wires.

Preferably, in the touch-controlled liquid crystal display panel, when the touch-controlled liquid crystal display panel is sensing a touch-input signal with one of the common electrodes, the control circuit provides a driving signal to the common electrode through the corresponding touch-sensing wire and receives the touch-input signal from the common electrode.

The present invention further provides another touch-controlled liquid crystal display panel including:

a first substrate;

a TFT array layer mounted on the first substrate;

a common-electrode layer mounted on the TFT array layer and having a plurality of common electrodes arranged in an array manner;

a touch-sensing layer mounted on the common-electrode layer for receiving a touch-input signal;

a dielectric layer mounted on the touch-sensing layer for insulating the common-electrode layer and a pixel-electrode layer from each other, wherein the pixel-electrode layer is mounted on the dielectric layer;

a liquid crystal layer mounted on the pixel-electrode layer; and

a second substrate mounted on the liquid crystal layer and having a black matrix; wherein the touch-sensing layer includes a plurality of touch-sensing wires; each of the touch-sensing wires is connected to the corresponding common electrode.

Preferably, in the touch-controlled liquid crystal display panel, each of the touch-sensing wires includes a transversely-extended portion and a longitudinally-extended portion, wherein the transversely-extended portion is electrically connected to the corresponding common electrode, and the longitudinally-extended portion is electrically connected to a control circuit.

Preferably, in the touch-controlled liquid crystal display panel, the touch-sensing wires on the touch-sensing layer are mounted in positions corresponding to the black matrix of the second substrate.

Preferably, in the touch-controlled liquid crystal display panel, when the touch-controlled liquid crystal display panel is displaying images, the control circuit provides a common signal to all the common electrodes through the touch-sensing wires.

Preferably, in the touch-controlled liquid crystal display panel, when the touch-controlled liquid crystal display panel is sensing a touch-input signal with one of the common electrodes, the control circuit provides a driving signal to the common electrode through the corresponding touch-sensing wire and receives the touch-input signal from the common electrode.

The present invention further provides a touch-controlled liquid crystal display apparatus including a touch-controlled liquid crystal display panel and a backlight module, wherein the touch-controlled liquid crystal display panel is mounted opposite to the backlight module; wherein, the touch-controlled liquid crystal display panel includes:

a first substrate;

a TFT array layer mounted on the first substrate;

a common-electrode layer mounted on the TFT array layer and having a plurality of common electrodes arranged in an array manner;

a touch-sensing layer mounted on the common-electrode layer for receiving a touch-input signal;

a dielectric layer mounted on the touch-sensing layer for insulating the common-electrode layer and a pixel-electrode layer from each other, wherein the pixel-electrode layer is mounted on the dielectric layer;

a liquid crystal layer mounted on the pixel-electrode layer; and

a second substrate mounted on the liquid crystal layer and having a black matrix; wherein

the touch-sensing layer includes a plurality of touch-sensing wires; each of the touch-sensing wires is connected to the corresponding common electrode.

Preferably, in the touch-controlled liquid crystal display apparatus, each of the touch-sensing wires includes a transversely-extended portion and a longitudinally-extended portion, wherein the transversely-extended portion is electrically connected to the corresponding common electrode, and the longitudinally-extended portion is electrically connected to a control circuit.

Preferably, in the touch-controlled liquid crystal display apparatus, the touch-sensing wires on the touch-sensing layer are mounted in positions corresponding to the black matrix of the second substrate.

Preferably, in the touch-controlled liquid crystal display apparatus, when the touch-controlled liquid crystal display panel is displaying images, the control circuit provides a common signal to all the common electrodes through the touch-sensing wires.

Preferably, in the touch-controlled liquid crystal display apparatus, when the touch-controlled liquid crystal display panel is sensing a touch-input signal with one of the common electrodes, the control circuit provides a driving signal to the common electrode through the corresponding touch-sensing wire and receives the touch-input signal from the common electrode.

Compared with the conventional technologies, in the touch-controlled liquid crystal display panel and the touch-controlled liquid crystal display apparatus provided by the present invention, by integrating the touch-sensing layer and the common-electrode layer into to the same layer in a way of mounting the touch-sensing wires on the common-electrode layer and connecting the touch-sensing wires with the corresponding common electrodes so that when touch-controlled liquid crystal display panel is displaying images, the control circuit can provide a common signal to the common electrodes through the touch-sensing wires; and when the touch-controlled liquid crystal display panel is sensing a touch-input signal with one of the common electrodes, the control circuit can provide a driving signal to the common electrode through the corresponding touch-sensing wire and receive the touch-input signal from the common electrode. The touch-controlled liquid crystal display panel and the touch-controlled liquid crystal display apparatus of the present are simple in structure so that the product yield rate of the prior art can be increased and the production cost can be reduced.

In order to make the contents of the present invention more easily understood, the preferred embodiments of the present invention are described in detail, in cooperation with accompanying drawings, as follows:

### BRIEF DESCRIPTION OF THE DRAWINGS

FIG. 1 is a structural schematic view of a touch-controlled liquid crystal display panel according to a preferred embodiment of the present invention;

FIG. 2 is a structural schematic view of a common-electrode layer provided according to a preferred embodiment of the present invention;

FIG. 3 is a structural schematic view showing the arrangement of touch-sensing wires provided according to a preferred embodiment of the present invention; and

FIG. 4 is a structural schematic view of the common-electrode layer provided according to another preferred embodiment of the present invention.

### DETAILED DESCRIPTION OF THE PREFERRED EMBODIMENTS

As used herein, the singular forms “a” and “an” are intended to include the plural forms as well, unless the context clearly indicates otherwise.

In the present invention, the main technical solution is to integrate a touch-sensing layer and a common-electrode layer into the same layer by forming the touch-sensing lines of the touch-sensing layer on the common-electrode layer and connecting the touch-sensing lines with a common electrode of the common-electrode layer. Therefore, when the touch-controlled liquid crystal display panel is displaying images, a control circuit thereof can provide a common signal to the common electrode through the touch-sensing lines; and when the touch-controlled liquid crystal display panel is sensing a touch input, the control circuit can provide a driving signal to the common electrode through the touch-sensing lines to receive the touch signal of touch input from the common electrode. The touch-controlled liquid crystal display panel of the present is simple in structure so that the product yield rate of the prior art can be increased and the production cost can be reduced.

Hereafter, embodiments of the technical solution of the present invention will be described more specifically as follows.

### First Embodiment

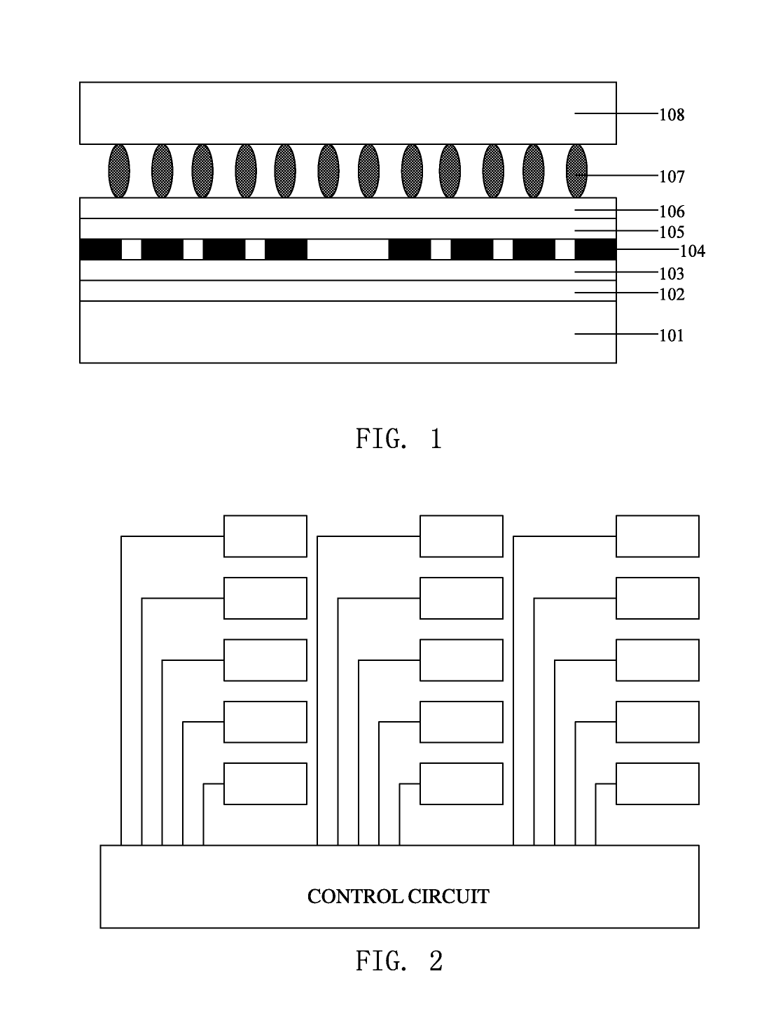

With reference to FIG. 1, FIG. 1 is a structural schematic view of a touch-controlled liquid crystal display panel according to a preferred embodiment of the present invention. For convenience of explanation, only portions related to the embodiment of the present invention are shown.

The touch-controlled liquid crystal display panel comprises a first substrate 101, a TFT array layer 102, a common-electrode layer 103, a touch-sensing layer 104, a dielectric layer 105, a pixel-electrode layer 106, a liquid crystal layer 107 and a second substrate 108. The TFT array layer 102 is mounted on the first substrate 101. The common-electrode layer 103 is mounted on the TFT array substrate 102. The common-electrode layer 103 has a plurality of common electrodes arranged in an array manner. The touch-sensing layer 104 is mounted on the common-electrode layer 103 for receiving a touch-input signal. The dielectric layer 105 is mounted on the touch-sensing layer 104. The dielectric layer 105 is used to insulate the common-electrode layer 103 and the pixel-electrode layer 106 from each other. The pixel-electrode layer 106 is mounted on the dielectric layer 105. The liquid crystal layer 107 is mounted on the pixel-electrode layer 106. The second substrate 108 is mounted on the liquid crystal layer 107. The second substrate 108 has a black matrix.

In this embodiment, the touch-sensing layer 104 includes a plurality of touch-sensing wires, and each of the touch-sensing wires is connected to the corresponding common electrode. Specifically, the embodiment may be implemented by integrating the touch-sensing layer 104 and the common-electrode layer 103 into the same layer by forming the touch-sensing wires of the touch-sensing layer 104 on the common-electrode layer 103 and connecting the touch-sensing wires and the common electrodes of the common-electrode layer 103.

However, it is understandable that the first substrate 101 may be a TFT substrate, and the second substrate may be a CF (short for color filter) substrate.

In this embodiment, the common electrodes of the common-electrode layer 103 may be grouped into multiple rows of touch-sensing pixels and multiple columns of the touch-sensing pixels, meaning that those touch-sensing pixels are arranged in an array manner. As shown in FIG. 2, numerals 2101, 2102, . . . to 2115 designate those touch-sensing pixels, and characters TX1, TX2, . . . to TX15 designate the touch-sensing wires, wherein each touch-sensing pixel corresponds to one of the touch-sensing wires. For example, the touch-sensing pixel 2101 is correspondingly connected to the touch-sensing wire TX1; the touch-sensing pixel 2102 is correspondingly connected to the touch-sensing wire TX2, the touch-sensing pixel 2115 is correspondingly connected to the touch-sensing wire TX15, and the rest may be deduced by analogy.

In this embodiment, the touch-sensing wires to which the same column of touch-sensing pixels correspond may be arranged at the same side. As shown in FIG. 2, which is a structural schematic view of the common-electrode layer provided according to a preferred embodiment of the present invention, the touch-sensing wires to which the same column of touch-sensing pixels correspond are arranged at the left side of the same column of touch-sensing pixels. However, it should be understandable that the touch-sensing wires can also be arranged at the right side of the same column of touch-sensing pixels.

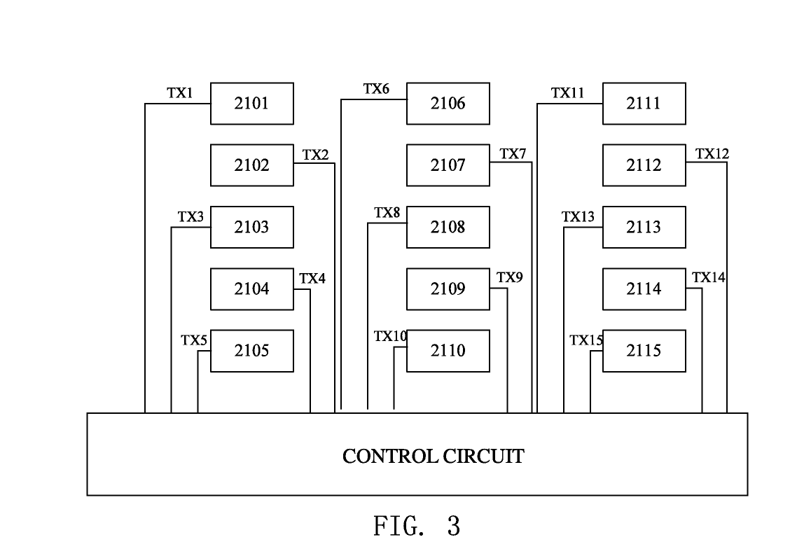

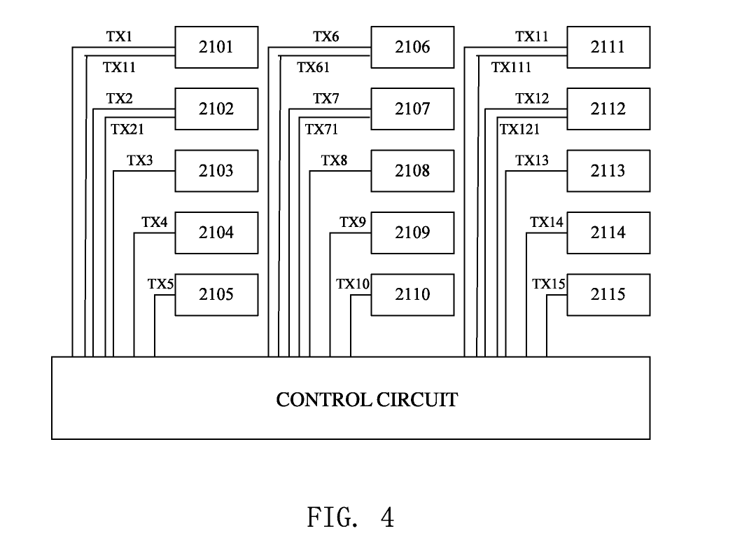

With further reference to FIG. 3, FIG. 3 is a structural schematic view showing the arrangement of touch-sensing wires provided according to another preferred embodiment of the present invention. In this embodiment, the touch-sensing wires to which the same column of touch-sensing pixels correspond may be left and right alternately arrange. That is, for example, the touch-sensing wire TX1 is mounted at the left side of the touch-sensing pixel 2101; the touch-sensing wire TX2 is mounted at the right side of the touch-sensing pixel 2102, the touch-sensing wire TX3 is mounted at the left side of the touch-sensing pixel 2103; the touch-sensing wire TX4 is mounted at the right side of the touch-sensing pixel 2104; and the rest may be deduced by analogy. In this embodiment, since the touch-sensing wires are arranged alternately at two sides of the column of touch-sensing pixels, the area of blind zone can be effectively reduced.

As a preferred embodiment of the present invention, the touch-sensing wires on the touch-sensing layer 104 may be arranged in positions corresponding to the black matrix of the second substrate 108. Therefore, a problem of display malfunction due to disconnection of the common electrodes can be avoided, thereby improving aperture ratio.

In this embodiment, each of the touch-sensing wires includes a transversely-extended portion and a longitudinally-extended portion, wherein the transversely-extended portion is electrically connected to the corresponding common electrode, and the longitudinally-extended portion is electrically connected to a control circuit.

In this embodiment, in order to reduce the variation among the common electrodes, the touch-sensing wires may be mounted on the common electrodes in a form of metal mesh.

It can be realized that, in the touch-controlled liquid crystal display panel provided in the first embodiment, by integrating the touch-sensing layer and the common-electrode layer into to the same layer in a way of mounting the touch-sensing wires on the common-electrode layer and connecting the touch-sensing wires with the corresponding common electrodes so that when touch-controlled liquid crystal display panel is displaying images, the control circuit can provide a common signal to the common electrodes through the touch-sensing wires; and when the touch-controlled liquid crystal display panel is sensing a touch-input signal with one of the common electrodes, the control circuit can provide a driving signal to the common electrode through the corresponding touch-sensing wire and receive the touch-input signal from the common electrode. The touch-controlled liquid crystal display panel of the present invention is simple in structure so that the product yield rate of the prior art can be increased and the production cost can be reduced.

### Second Embodiment

With reference to FIG. 4, FIG. 4 is a structural schematic view of the common-electrode layer provided according to another preferred embodiment of the present invention. For convenience of explanation, only portions related to the embodiment of the present invention are shown. The second embodiment is basically similar to the first embodiment, but the second embodiment differs from the first embodiment in that:

In the second embodiment, the common electrodes of the common-electrode layer 103 are grouped into multiple rows of touch-sensing pixels and multiple columns of the touch-sensing pixels. That is, the touch-sensing pixels are arranged in an array manner. As shown in FIG. 2, numerals 2101, 2102, . . . to 2115 designate those touch-sensing pixels, and characters TX1, TX2, . . . to TX15 designate the touch-sensing wires, wherein each of the touch-sensing pixels may correspond to one or more touch-sensing wires. For example, the touch-sensing pixel 2101 is correspondingly connected to the touch-sensing wire TX1 and the touch-sensing wire TX11; the touch-sensing pixel 2102 is correspondingly connected to the touch-sensing wire TX2 and the touch-sensing wire TX21; the touch-sensing pixel 2115 is correspondingly connected to the touch-sensing wire TX15; and the rest may be deduced by analogy.

However, it should be understandable that the number of the touch-sensing wires to which the touch-sensing pixel being farther from the control circuit is connected is greater than the number of the touch-sensing wires to which the touch-sensing pixel being closer to the control circuit. For example, the touch-sensing pixel 2101, which is farther from the control circuit, is correspondingly connected to the touch-sensing wire TX1 and the touch-sensing wire TX11; the touch-sensing pixel 2102 is correspondingly connected to the touch-sensing wire TX2 and the touch-sensing wire TX21; and the touch-sensing pixel 2115, which is closer to the control circuit, is correspondingly connected only to the touch-sensing wire TX15. And the rest may be deduced by analogy.

In this embodiment, since the number of the touch-sensing wires to which the touch-sensing pixel being farther from the control circuit is connected is greater than the number of the touch-sensing wires to which the touch-sensing pixel being closer to the control circuit, a problem of excessive resistance can be effectively improved. The resistance in the wiring is effectively reduced.

The present invention further provides a touch-controlled liquid crystal display apparatus. The touch-controlled liquid crystal display apparatus includes the foregoing touch-controlled liquid crystal display panel and a backlight module. The touch-controlled liquid crystal display panel is mounted opposite to the backlight module.

The touch-controlled liquid crystal display panel in the touch-controlled liquid crystal display apparatus includes a first substrate 101, a TFT array substrate 102, a common-electrode layer 103, a touch-sensing layer 104, a dielectric layer 105, a pixel-electrode layer 106, a liquid crystal layer 107 and a second substrate 108. The TFT array substrate 102 is mounted on the first substrate 101. The common-electrode layer 103 is mounted on the TFT array substrate 102. The common-electrode layer 103 has a plurality of common electrodes arranged in an array manner. The touch-sensing layer 104 is mounted on the common-electrode layer 103. The touch-sensing layer 104 is used to receive a touch-input signal. The dielectric layer 105 is mounted on the touch-sensing layer 104. The dielectric layer 105 is used to insulate the common-electrode layer 103 and the pixel-electrode layer 106 from each other. The pixel-electrode layer 106 is mounted on the dielectric layer 105. The liquid crystal layer 107 is mounted on the pixel-electrode layer 106. The second substrate 108 is mounted on the liquid crystal layer 107. The second substrate 108 has a black matrix.

In this embodiment, in the touch-controlled liquid crystal display apparatus, the touch-sensing layer includes a plurality of touch-sensing wires; each of the touch-sensing wires is connected to the corresponding common electrode. Thus, unlike the situation in a traditional full in-cell touch screen where sensing electrodes and signal wires are initially insulated from each other, which has to form conducting through holes to connect the sensing electrodes and the connecting wires, thereby resulting in a complicated structure and causing a problem of low yields, the simple structure provided in the present invention solve can avoid the such problem of the prior art.

In this embodiment, in the touch-controlled liquid crystal display apparatus, each of the touch-sensing wires includes a transversely-extended portion and a longitudinally-extended portion; the transversely-extended portion is electrically connected to the corresponding common electrode, and the longitudinally-extended portion is electrically connected to a control circuit.

In this embodiment, in the touch-controlled liquid crystal display apparatus, the touch-sensing wires on the touch-sensing layer are mounted in positions corresponding to the black matrix of the second substrate. Therefore, a problem of display malfunction due to disconnection of the common electrodes can be avoided, thereby improving aperture ratio.

In this embodiment, in the touch-controlled liquid crystal display apparatus, since a time-shared scanning technique is employed to touch-sensing and image-displaying, the common electrodes are not only used as a common-voltage (Vcom) layer in the image-displaying stage, but also are used as the receiver for receiving touch-input signal in the touch-sensing stage. That is, when the touch-controlled liquid crystal display panel is displaying images, the control circuit provides a common signal to all the common electrodes through the touch-sensing wires; and when the touch-controlled liquid crystal display panel is sensing a touch-input signal with one of the common electrodes, the control circuit provides a driving signal to the common electrode through the corresponding touch-sensing wire and receives the touch-input signal from the common electrode.

In conclusion, in the touch-controlled liquid crystal display panel and the touch-controlled liquid crystal display apparatus of the present invention, by integrating the touch-sensing layer and the common-electrode layer into to the same layer in a way of mounting the touch-sensing wires on the common-electrode layer and connecting the touch-sensing wires with the corresponding common electrodes so that when touch-controlled liquid crystal display panel is displaying images, the control circuit can provide a common signal to all the common electrodes through the touch-sensing wires; and when the touch-controlled liquid crystal display panel is sensing a touch-input signal with one of the common electrodes, the control circuit can provide a driving signal to the common electrode through the corresponding touch-sensing wire and receive the touch-input signal from the common electrode. The touch-controlled liquid crystal display panel and the touch-controlled liquid crystal display apparatus of the present invention are simple in structure so that the product yield rate of the prior art can be increased and the production cost can be reduced.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The present invention has been described with preferred embodiments thereof, and it is understood that many changes and modifications to the described embodiment can be carried out without departing from the scope and the spirit of the invention that is intended to be limited only by the appended claims.

What is claimed is:

1. A touch-controlled liquid crystal display panel comprising:
a first substrate;
a TFT array layer mounted on the first substrate;
a common-electrode layer mounted on the TFT array layer and having a plurality of common electrodes arranged in an array manner;
a touch-sensing layer mounted on the common-electrode layer for receiving a touch-input signal;
a dielectric layer mounted on the touch-sensing layer for insulating the common-electrode layer and a pixel-electrode layer from each other, wherein the pixel-electrode layer is mounted on the dielectric layer;
a liquid crystal layer mounted on the pixel-electrode layer; and
a second substrate mounted on the liquid crystal layer and having a black matrix; wherein
the touch-sensing layer includes a plurality of touch-sensing wires; each of the touch-sensing wires is connected to the corresponding common electrode; each of the touch-sensing wires includes a transversely-extended portion and a longitudinally-extended portion, wherein the transversely-extended portion is electrically connected to the corresponding common electrode, and the longitudinally-extended portion is electrically connected to a control circuit; the touch-sensing wires on the touch-sensing layer are mounted in positions corresponding to the black matrix of the second substrate.

2. The touch-controlled liquid crystal display panel as claimed in claim 1, wherein when the touch-controlled liquid crystal display panel is displaying images, the control circuit provides a common signal to all the common electrodes through the touch-sensing wires.

3. The touch-controlled liquid crystal display panel as claimed in claim 1, wherein when the touch-controlled liquid crystal display panel is sensing a touch-input signal with one of the common electrodes, the control circuit provides a driving signal to the common electrode through the corresponding touch-sensing wire and receives the touch-input signal from the common electrode.

4. A touch-controlled liquid crystal display panel comprising:
a first substrate;
a TFT array layer mounted on the first substrate;
a common-electrode layer mounted on the TFT array layer and having a plurality of common electrodes arranged in an array manner;
a touch-sensing layer mounted on the common-electrode layer for receiving a touch-input signal;
a dielectric layer mounted on the touch-sensing layer for insulating the common-electrode layer and a pixel-electrode layer from each other, wherein the pixel-electrode layer is mounted on the dielectric layer;
a liquid crystal layer mounted on the pixel-electrode layer; and
a second substrate mounted on the liquid crystal layer and having a black matrix; wherein the touch-sensing layer includes a plurality of touch-sensing wires; each of the touch-sensing wires is connected to the corresponding common electrode.

5. The touch-controlled liquid crystal display panel as claimed in claim 4, wherein each of the touch-sensing wires includes a transversely-extended portion and a longitudinally-extended portion, wherein the transversely-extended portion is electrically connected to the corresponding common electrode, and the longitudinally-extended portion is electrically connected to a control circuit.

6. The touch-controlled liquid crystal display panel as claimed in claim 4, wherein the touch-sensing wires on the touch-sensing layer are mounted in positions corresponding to the black matrix of the second substrate.

7. The touch-controlled liquid crystal display panel as claimed in claim 4, wherein when the touch-controlled liquid crystal display panel is displaying images, the control circuit provides a common signal to all the common electrodes through the touch-sensing wires.

8. The touch-controlled liquid crystal display panel as claimed in claim 4, wherein when the touch-controlled liquid crystal display panel is sensing a touch-input signal with one of the common electrodes, the control circuit provides a driving signal to the common electrode through the corresponding touch-sensing wire and receives the touch-input signal from the common electrode.

9. A touch-controlled liquid crystal display apparatus comprising a touch-controlled liquid crystal display panel and a backlight module, wherein the touch-controlled liquid crystal display panel is mounted opposite to the backlight module; wherein, the touch-controlled liquid crystal display panel includes:
a first substrate;
a TFT array layer mounted on the first substrate;
a common-electrode layer mounted on the TFT array layer and having a plurality of common electrodes arranged in an array manner;
a touch-sensing layer mounted on the common-electrode layer for receiving a touch-input signal;
a dielectric layer mounted on the touch-sensing layer for insulating the common-electrode layer and a pixel-electrode layer from each other, wherein the pixel-electrode layer is mounted on the dielectric layer;
a liquid crystal layer mounted on the pixel-electrode layer; and
a second substrate mounted on the liquid crystal layer and having a black matrix; wherein
the touch-sensing layer includes a plurality of touch-sensing wires; each of the touch-sensing wires is connected to the corresponding common electrode.

10. The touch-controlled liquid crystal display apparatus as claimed in claim 9, wherein each of the touch-sensing wires includes a transversely-extended portion and a longitudinally-extended portion, wherein the transversely-extended portion is electrically connected to the corresponding common electrode, and the longitudinally-extended portion is electrically connected to a control circuit.

11. The touch-controlled liquid crystal display apparatus as claimed in claim 9, wherein the touch-sensing wires on the touch-sensing layer are mounted in positions corresponding to the black matrix of the second substrate.

12. The manufacturing method as claimed in claim 9, wherein when the touch-controlled liquid crystal display panel is displaying images, the control circuit provides a common signal to all the common electrodes through the touch-sensing wires.

13. The touch-controlled liquid crystal display apparatus as claimed in claim 9, wherein when the touch-controlled liquid crystal display panel is sensing a touch-input signal with one of the common electrodes, the control circuit provides a driving signal to the common electrode through the corresponding touch-sensing wire and receives the touch-input signal from the common electrode.
